(19) United States
(12) Patent Application Publication
(10) Pub. No.: US 2017/0358231 A1
(43) Pub. Date: Dec. 14, 2017

(54) METHOD AND SYSTEM FOR FACILITATING PROVISIONING OF MEDIA FOR INSTRUCTIONAL USE

(71) Applicant: Angela King, Ashland, VA (US)

(72) Inventor: Angela King, Ashland, VA (US)

(21) Appl. No.: 15/620,622

(22) Filed: Jun. 12, 2017

Related U.S. Application Data
(60) Provisional application No. 62/348,574, filed on Jun. 10, 2016.

(51) Int. Cl. G09B 5/06; G09B 19/02; G09B 17/00; G06F 17/30; G09B 19/00; G06F 17/27

(52) U.S. Cl. CPC G09B 5/065; G09B 19/00; G06F 17/277; G09B 17/006; G06F 17/30979; G06F 17/2785; G09B 19/025

(57) ABSTRACT

Disclosed is a method for facilitating provisioning of media for instructional use. The method includes retrieving, using a storage device, one or more media. Further, the method includes receiving, using a processing device, one or more instructional topics. Yet further, the method includes analyzing, using a processing device, the one or more media. Further, the method includes identifying, using the processing device, one or more contextual tokens associated with the one or more instructional topics based on the analyzing. Moreover, the method includes storing, using the storage device, each of the one or more contextual tokens and the one or more instructional topics in association with the one or more contextual tokens.

The current application claims a priority to the U.S. Provisional Patent application Ser. No. 62/348,574 filed on Jun. 10, 2016.

### FIELD OF THE INVENTION

The present invention relates to categorizing information. In particular, the present invention relates to a method and a system for facilitating provisioning of media for instructional use.

### BACKGROUND OF THE INVENTION

Educators sometimes use literature and other forms of art or media to instruct learners regarding a specific attribute, feature, strategy or technique, relying on examples within the art or media. For example, language instructors have been using audio and visual excerpts from popular culture in their classes for many decades. This media may expose learners to various accents or other academically relevant material. Various types of media can play a valuable role in the learning process. Many instructors include media as an important part of their lesson plans.

However, this often involves instructors taking an open-ended, imprecise look at media that may have the desired content. This is manual activity which may consume a lot of time of the instructors. Further, the instructors may not be able to find suitable media content for many concepts.

Therefore, there is a need for improved methods and systems to provide relevant media content to instructors such that they may access and share media content safely and efficiently.

### SUMMARY OF THE INVENTION

This summary is provided to introduce a selection of concepts in a simplified form that are further described below in the Detailed Description. This summary is not intended to identify key features or essential features of the claimed subject matter. Nor is this summary intended to be used to limit the claimed subject matter's scope.

Disclosed is a method for facilitating provisioning of media for instructional use. The method includes retrieving, using a storage device, one or more media. Further, the method includes receiving, using a processing device, one or more instructional topics. Yet further, the method includes analyzing, using a processing device, the one or more media. Further, the method includes identifying, using the processing device, one or more contextual tokens associated with the one or more instructional topics based on the analyzing. Moreover, the method includes storing, using the storage device, each of the one or more contextual tokens and the one or more instructional topics in association with the one or more contextual tokens.

According to some aspects, a method for facilitating provisioning of media for instructional use is disclosed. The method includes retrieving, using a storage device, one or more media. Further, the method includes receiving, using a processing device, one or more instructional topics. Yet further, the method includes analyzing, using a processing device, the one or more media. Further, the method includes identifying, using the processing device, one or more contextual tokens associated with the one or more instructional topics based on the analyzing. Moreover, the method includes storing, using the storage device, each of the one or more contextual tokens and the one or more instructional topics in association with the one or more contextual tokens.

According to some aspects, a system for categorizing information is disclosed. The system may be configured for grouping and distributing information based on contextual similarities. Further, the system may enable instructors and learners to access preformatted information that is related to a particular subject.

According to some aspects, an Instructional Review of Media for Academic Application (IRMA) is disclosed. IRMA may be used perform a detailed mining or mapping of media content to locate, identify and catalog the specific attribute, feature, strategy or technique to make possible a consistent, widespread educational application. Further, IRMA may provide a pre-prepared selection of information that is a quantifiable method of knowing what aspects are located within the media. Therefore, IRMA may provide a type of “instructor's manual” for the instructor. Further, IRMA is configured for systematically locating and recommending the media that may be best suited for a particular instructional need. For example, the attributes, features, strategies or techniques that might be located, categorized, cataloged, or recommended from various media would include but not be limited to:

Spelling features, such as an abundance of words with short E or SH endings or SUB as a prefix.

Vocabulary words, such as the use of the word “read” in a certain context

Literary devices, such as metaphor or simile

Scientific, mathematical or social science examples, in context, such as a theme of Einstein's Theory of Relativity or a reference to the Pythagorean Theorem or a plot line featuring Mount Rushmore.

According to further aspects, IRMA distribution methods may include, but not be limited to Instructional Review of Books for All Learners (IRBAL), Instructional Review of Books for Youth (IRBY), Instructional Review of Film for All Learners (IRFAL), Instructional Review of Film for Youth (IRFY), Instructional Review of Performing Arts for All Learners (IRPAL), Instructional Review of Performing Arts for Youth (IRPY), Instructional Review of Songs for All Learners (IRSAL), Instructional Review of Songs for Youth (IRSY), Instructional Review of Visual Art for Learners (IRVAL), Instructional Review of Visual Art for Youth (IRVY). Further, IRMA distribution methods may include Names in Context (NIC), which is a directory of media sources designed to be searched for specific proper name information. Further, IRMA distribution methods may include Places in Context (PIC), which is a compendium of media sources designed to be searched for specific place name information. Further, IRMA distribution methods may include Vocabulary in Context (VIC), which is a media dictionary of sources within which a user might search for a word and find directions for where to locate it in actual media. Additionally, VIC may be used to find an informational scale indicating how concretely the context clues define the word. Yet further, IRMA distribution methods may include a Compendium of Hyperbole, Idiom, Metaphor, Euphemism and Simile (CHIMES) and other expressions used in media.

According to some aspects, IRMA may provide a method for deconstructing a selection of source material into groups of contextual tokens, forming a dynamic array of the contextual tokens, and distributing formatted sections of the dynamic array. The method may further include two methods—an information gathering method and a presentation method. These two methods may be employed to form and map data in a dynamic array, and to generate a collection of formatted results that satisfy specific inclusion criteria. The information gathering method may be used to generate contextual tokens from a wide variety of source material including, but not limited to, picture books, songs, movies, plays, novels, biographies, scientific articles, textbooks, newspapers, websites and online databases.

The contextual tokens may be gathered into relational groups and arranged in a dynamic array. Each element of the dynamic array may contain the addresses of groups of related contextual tokens. A single contextual token may be referenced by several elements in the array. However, only references that satisfy the specified inclusion criteria may be included as formatted results. Further, the relevant dynamic array elements may be formatted to be disseminated via the selected presentation medium. Further, the method output may be formatted for presentation in print media, such as books, magazines, posters, pamphlets, or cards. Additionally, the method output may be formatted for digital dissemination. Both the information gathering method and presentation method may be performed by one or both of human operatives and software applications. Accordingly, the method may use a combination of manned and unmanned information gathering and presentation methods.

Further, the information gathering method may be used to quantify and categorize various contextual tokens that are present in a source media. The information gathering method may include the following steps. First step is to gather the source material. Second step is to process source material and tag contextual tokens. Third step is to group processed material based on contextual tokens. Fourth step is to generate a dynamic relational array of contextual tokens. Final step is to map the dynamic array. The first step in the method is to gather the source material. The source material may be any form of media that may be useful to instructors, students, or learners in general. It may be digital or print-based media. Movies, plays, and music may also be used as source material. After source material has been gathered, the second step is to parse the source material and tag contextual tokens. The contextual tokens are points of interest within a source material that may be used to relate the content in the source material to various elements of the dynamic array. For example, contextual tokens may be spelling features, such as an abundance of words with short “E” or “SH” endings or “SUB” as prefix. Contextual tokens may be vocabulary words, such as the use of the word “read” in a certain context. Additionally, contextual tokens may be literary devices, scientific, mathematical, or social science examples, in context. The contextual tokens may be images, or scenes from pictures and movies. In a further embodiment, a specific chord progression or musical composition may be used as a contextual token.

Once the source material has been parsed and organized into contextual tokens, the third step is to group together the contextual tokens based on similarities in context. More particularly, a reference to the location of each contextual token may be placed within a group of references to other contextual tokens that relate to a similar context. A single contextual token may be referenced by several contextual groups. After the contextual tokens have been organized into contextual groups, the fourth step is to generate a dynamic relational array using the contextual groups. Each contextual group may be inserted into an element of the dynamic relational array.

One element of the dynamic relational array may hold the locations of specific contextual tokens, as well as, the locations of several other dynamic relational array elements. As an example, an array element dedicated to books may contain the locations of other array elements that pertain to specific genres or sub-genres of books. Additionally, an array element may contain the locations of contextual tokens that are related to specific types of films; for instance, films with strong female lead characters. Furthermore, dynamic relational array elements may contain groups of contextual tokens that reference source material from the theater and other performing arts, such as all adaptations of Samuel Beckett's Waiting for Godot. Further, dynamic relational array element locations may be assigned to groups of contextual tokens from a multitude of sources. It is an aim of the present disclosure to generate an array that may be continually expanded, and whose elements may contain references to specific contextual tokens as well as references to other elements of the dynamic relational array.

The final step in the information gathering method is to map the dynamic relational array index. Mapping the dynamic relational array may involve gathering the addresses of array elements that relate to specific topics. By gathering the addresses of related array elements, the information gathering method may be able to generate a map of the all possible topics of inquiry. Further, the method may index mapped elements of the dynamic relational array in such a way that the indexes may be compiled to form a compendium of related contextual tokens that have been gathered from a wide variety of source material.

The presentation method may be used to aggregate the contextual tokens that satisfy specific inclusion criteria, and to format these aggregated tokens for a selected presentation medium. The presentation method may include as many as six steps. The first step is to select the presentation medium. The second step is to select the inclusion criteria. The third step is to compare the inclusion criteria to the dynamic relational array index. The fourth step is to aggregate the dynamic relational array elements that satisfy the inclusion criteria. The fifth step is to format the aggregated array elements for the selected inclusion criteria. The sixth, and final step, is to distribute the formatted dynamic relational array elements via the selected presentation medium.

The presentation method may be used to distribute the contextual tokens that have been gathered and formatted by the IRMA system. It is an aim of the present disclosure to create a method that may be interacted with via a digital interface. The present disclosure may enable a user to describe inclusion criteria from a digital interface, such as a computer program, mobile application, or web interface. Additionally, the presentation method may be used to format elements of the dynamic relational array that satisfy the inclusion criteria in such a way that the formatted elements may be presented via digital interface. Presentation media may include books, magazines, specialty cards, pamphlets, emails, web pages, articles, blogs, computer programs, mobile applications, text messages, or various other types of print and digital media.

The first step in the presentation method is to select the presentation medium. The IRMA system may be used to disseminate context related information through a variety of presentation media, an integral step in the process is to determine the precise presentation medium that may be used to dictate the formatting requirements. A user may interact with the IRMA system to input inclusion criteria via a digital interface, but may elect to have the presentation medium formatted for printed dissemination. The type of contextual tokens included in the formatted results will differ depending on the selected presentation medium. For example, if the selected inclusion medium is a book, the formatted results may not contain hyperlinks or imbedded multimedia files. Additionally, a selected presentation medium may be a specialty card that contains a picture or word along with various related information.

Once the presentation medium has been selected, the second step is to select the inclusion criteria. The inclusion criteria may be as broad as scientific or mathematic tokens that are associated with the theme of Einstein's theory of relativity. Further, the inclusion criteria may be literary devices such as metaphor or simile. Furthermore, the inclusion criteria may include hyperbole, idiom, metaphor, simile, euphemism, sarcasm, vernacular and other colloquialisms used in media. After the inclusion criteria have been selected the third step in the presentation method is to compare the inclusion criteria to the elements of the dynamic relational array. This step may include comparing the inclusion criteria to the map of the dynamic relational array and select the indexes that contain references to relevant contextual tokens. After the inclusion criteria have been compared to the dynamic relational array, the fourth step is to aggregate the relevant contextual tokens into a selection of contextual tokens that are relevant to the specified inclusion criteria. This aggregated information may contain contextual tokens from videos, books, magazines, web pages, songs, documents, poems, works of art, or scientific theory, so long as the contextual tokens are relevant to the specified inclusion criteria. Additionally, the inclusion criteria may specify if the aggregated data should include tokens that are age specific or otherwise limitable based on developmental or utilitarian needs or other such search criteria.

The fifth step is to format the aggregated array elements for the selected inclusion criteria. Depending on the selected presentation medium the method may use different formatting requirements to display the aggregated information relevant to the specified inclusion criteria. If the selected presentation medium is a book, the formatted information may be arranged onto pages and subdivided into chapters and sections. If the selected presentation medium is a web page, the formatted information may be displayed in web pages with links that redirect a user of the present invention to other web pages that contain relevant information. Various formatting requirements may be enforced depending on the selected presentation medium.

After the information has been gathered, parsed, selected and formatted, the final step in the presentation method is to distribute the formatted dynamic relational array elements via the selected presentation medium. It is an aim of the present disclosure to make the information that has been gathered by the IRMA system available on a wide variety of presentation media. The IRMA system may be used to generate a compendium of media sources within which a user may search for a word or phrase, and find directions for where to locate it in actual media. For example, if a user is looking for references to the phrase “kicked the bucket” the material distributed by the IRMA system may contain the part of speech the phrase refers to, a definition of the phrase, a contextual excerpt containing the phrase, the location within a source material where the phrase may be found, and a review or rating of how effectively the context defines the word. This information may be distributed via a web page that generates a formatted list of related contextual tokens. The IRMA system may be used to generate books containing many of the contextual tokens that are relevant to a particular subject. For example, the IRMA system may be used to generate a list of literature and movies that feature Byronic heroes or Ashanti customs or the concept of evaporation—suitable for a specific, guided reading level or other particular teaching application.

The ability to obtain this output ahead of the study endeavor, the level of precise specificity, the potential presentation of multiple examples, and the assessment of usefulness for instruction within these reviews are among the factors that differentiate this invention from earlier practices of simply locating and offering general examples within media. The distributed information may be formatted into instructional guides related to particular inclusion criteria. In addition to contextual tokens, the IRMA system may be used to generate formatted reviews of how useful a group of aggregated tokens will be when used as a teaching aid.

According to some aspects, the materials created by the disclosed methods and system comply with copyright fair use practices. The disclosed methods and system make the original material more useful and more desirable for consumers, thus promote purchase and support of the source material. Further, the disclosed methods and system provide only sufficient information in each case to connect the user to the original work and not otherwise replicate large portions of the work without specific permission from the creator of the original work. The information presented to the instructional user may be comparable to a review, which is allowed under fair use.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 illustrates an exemplary environment in which embodiments of the present disclosure may be implemented.

FIG. 2 illustrates a block diagram of a system for facilitating provisioning of media for instructional use in accordance with some embodiments.

FIGS. 3A and 3B illustrates example media in accordance with some embodiments.

FIG. 4 illustrates a flowchart of a method for facilitating provisioning of media for instructional use in accordance with some embodiments.

FIG. 5 illustrates a flowchart of a method for ranking media for instructional use in accordance with some embodiments.

FIG. 6 illustrates a flowchart of a method for reviewing media and instructional topic in accordance with some embodiments.

FIG. 7 illustrates a flowchart of a method for receiving free form complex queries from instructors in accordance with some embodiments.

FIG. 8 illustrates a flowchart of a method of facilitating provisioning of media for instructional use in accordance with some embodiments.

FIG. 9 illustrates an exemplary computing system that may be employed to implement processing functionality for various embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of provisioning media, embodiments of the present disclosure are not limited to use only in this context.

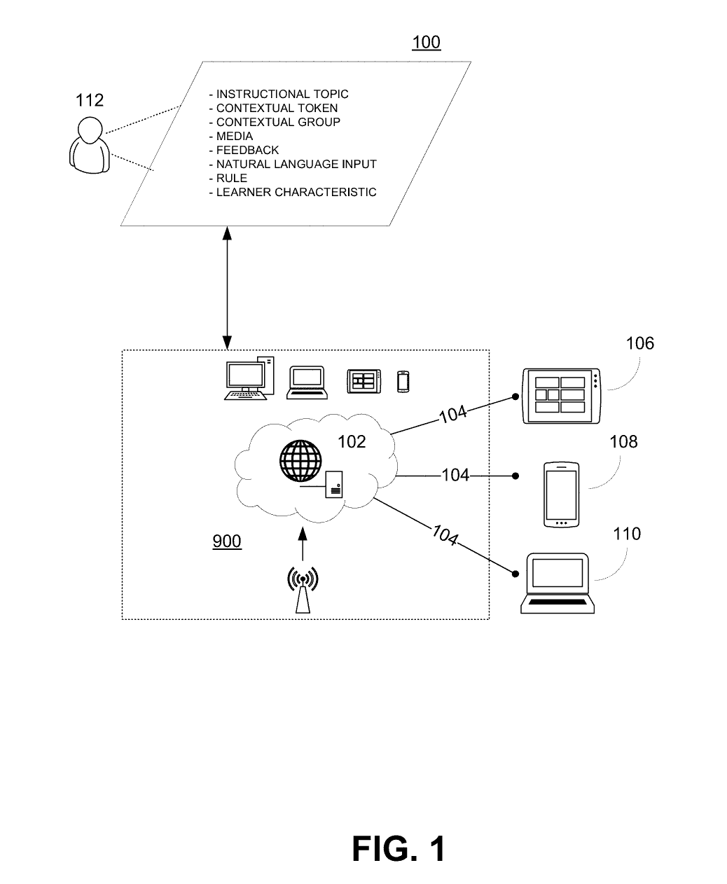

FIG. 1 is an illustration of a platform consistent with various embodiments of the present disclosure. By way of non-limiting example, the online platform 100 for facilitating provisioning of media for instructional use may be hosted on a centralized server 102, such as, for example, a cloud computing service. The centralized server 102 may communicate with other network entities, such as, for example, a mobile device (such as a smartphone, a laptop, a tablet computer etc.) and other electronic devices (such as desktop computers, etc.) over a communication network 104, such as, but not limited to, the Internet. Further, users of the platform may include one or more relevant parties such as, instructors, learners and reviewers. Accordingly, electronic devices operated by the one or more relevant parties may be in communication with the platform. For example, the platform 100 may be in communication with an instructor electronic device 106 operated by the instructor, a learner electronic device 108 operated by the learner and a reviewer electronic device 110 operated by the reviewer.

A user 112, such as the one or more relevant parties, may access platform 100 through a software application. The software application may be embodied as, for example, but not be limited to, a website, a web application, a desktop application, and a mobile application compatible with a computing device 900. Accordingly, in an instance, the user 112 may be an instructor who may request for relevant media corresponding to a certain instructional topic.

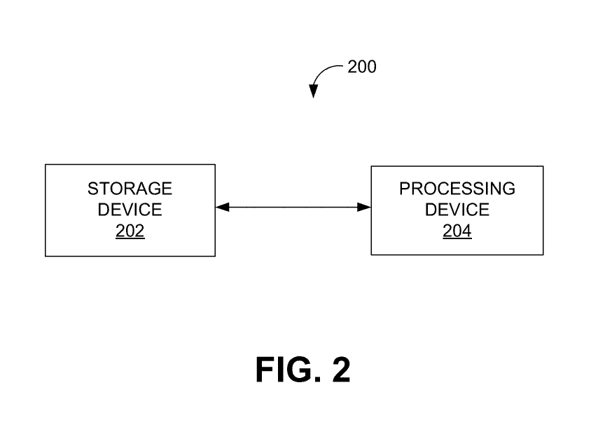

Turning to FIG. 2, a system 200 for facilitating provisioning of media for instructional use, in accordance with some embodiments. The media may include one or more of books, drawings, photos, audios, videos, multimedia content and virtual reality content. The instructional use may include teaching at one or more of K-12 schools, colleges, universities, corporate events, and military training. As shown, the system 200 includes a storage device 202 and a processing device 204.

The storage device 202 may be configured for retrieving one or more media. Further, the storage device 202 may be configured for storing each of one or more contextual tokens and one or more instructional topics in association with the one or more contextual tokens. The one or more contextual tokens may include one or more sections of an article, a website, a book, a drawing, a photo, an audio, and a video. For example, one or more sections of a book may include a phrase, a clause, a sentence, a paragraph. The one or more instructional topics may include topics that an instructor may wish to teach learners. For example, English spelling with SH endings, English vocabulary, literary device (like metaphors). Further, scientific, mathematical and social science instructional topics may include Einstein's Theory of Relativity, Pythagorean Theorem and Future cities.

For example, an instructional topic may be the phrase “cut off”. Accordingly, the contextual token may include at least some of the following information:

Idiom meaning “to interrupt”

Can be found in:

The Thief Lord by Cornelia Funke

Scholastic, © 2000

Interest Level 5th-9th

Reading Level V

Page 133

“‘Shut up, Bo!’ Prosper cut him off.”

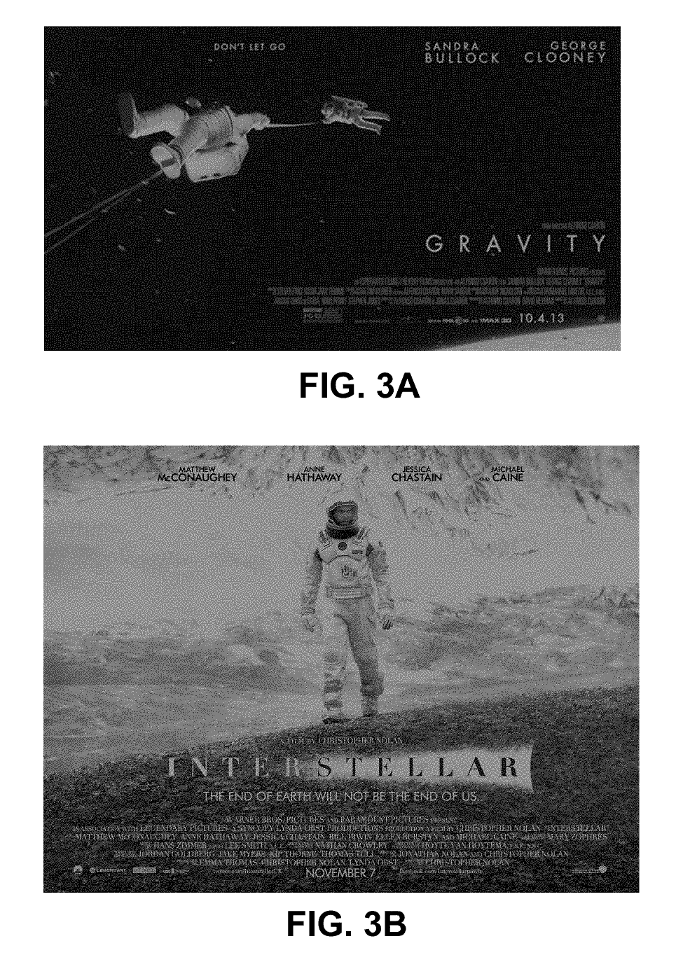

The processing device 204 may be configured for receiving one or more instructional topics, analyzing the one or more media and identifying the one or more contextual tokens associated with the one or more instructional topics based on the analyzing. The one or more media may include one or more of an audio content, a video content, a multimedia content, wherein the analyzing may include performing at least one of image analysis and audio analysis. The image analysis and audio analysis of the media may be performed in order to determine one or more of scenes, objects, people, and sentiment, and identify the corresponding contextual tokens. For example, the image analysis and audio analysis may be performed on the movie “Gravity” to identify content related to “Zero Gravity” as shown in FIG. 3A. Similarly, the image analysis and audio analysis may be performed on the movie “Interstellar” to identify content related to “Wormholes” as shown in FIG. 3B.

Further, the one or more contextual tokens may include one or more of a spelling feature, a vocabulary word, a literary concept, a scientific concept and a mathematical concept. Further, the literary concept may include one or more of hyperbole, idiom, metaphor and simile, euphemism, sarcasm, vernacular and other expressions.

Further, the processing device 204 may be configured for analyzing a media (such as a book) in relation to an instructional topic (such as teaching pronunciation of certain kinds of words) and identifying a mapping between the instructional topic and the media. For example, an instructional topic may be “words with silent letters”. The processing device 204 may be configured to identify contextual tokens (such as words, paragraphs, and sentences) in the media (such as the book) that include words with silent letters. Further, the contextual tokens and the instructional topic may be associated and stored in the storage device 202 for future use. As a result, other users who may need to identify an appropriate media for imparting an instructional topic to learners may query the storage device 202 with the instructional topic (such as words with silent letters). Accordingly, such users may be presented with the contextual tokens associated with the instructional topic that were previously identified.

In some embodiments, the processing device 204 may be further configured for identifying the one or more instructional topics based on the analyzing, wherein the analyzing is performed based on one or more predetermined rules. Accordingly, the processing device 204 may automatically analyses the media and identify various instructional topics. An expert may provide predetermined rules that may facilitate discovery of such instructional topics. Subsequently, the processing device 204 may identify contextual tokens associated with the identified instructional topics.

In some embodiments, the one or more contextual tokens may include multiple contextual tokens, wherein the system 200 may be further configured to group the multiple contextual tokens into one or more contextual groups based on contextual similarity associated with the multiple contextual tokens. For example, the contextual tokens may be similar with regard to a reading level, a media type, and a theme. Accordingly, a learner may experience greater re-enforcement of learning with regard to the instructional topic while consuming the media containing the contextual tokens because of consistency in instruction delivery.

In some embodiments, the processing device 204 may be further configured for determining a number of instances corresponding to each of the one or more contextual tokens and ranking the one or more media based on the number of instances corresponding to the one or more media. Accordingly, a media (such as a book) which has more number of instances of a contextual token for a given instructional topic may be given a higher rank than other media with fewer instances. The media with more number of instances of a contextual token for a given instructional topic may be considered “richer” from a pedagogical standpoint. Therefore, the media with more number of instances may be delivered to users to teach the corresponding instructional topic.

In some embodiments, the system 200 may include a communication device configured for transmitting each of the one or more media and the instructional topic to an electronic device associated with a reviewer and receiving a feedback from the electronic device. The feedback may be provided by the reviewer, wherein the identifying of the one or more contextual tokens may be further based on the feedback. Accordingly, a feedback may be received from an expert human reviewer. For example, the feedback may be an approval of the contextual token identified automatically by the system 200. Alternatively, the feedback may be guidance provided by the expert that may facilitate identifying of the contextual token.

In further embodiments, the communication device may be further configured for receiving one or more instructional goals in natural language form. Further, the processing device 204 may be further configured for analyzing the one or more instructional goals in order to determine the one or more instructional topics. Accordingly, the system 200 may receive free form complex queries from instructors which may then be analyzed in order to identify the one or more instructional topics. The identified topics may then be used to retrieve the relevant media having the contextual tokens.

In further embodiments, the communication device may be further configured for receiving one or more learner characteristics associated with the instructional topic, wherein the identifying of the one or more contextual tokens may be further based on the one or more learner characteristics. For example, the one or more learner characteristics may include one or more of reading level, age of learners, language, and culture. Accordingly, the processing device 204 may identify media that meets specific requirements such as reading level, age of learners, language, culture.

In further embodiments, the one or more instructional topics may correspond to music, wherein the communication device may be configured to transmit the one or more contextual tokens to a musical instrument, wherein the musical instrument may be configured to play the one or more contextual tokens. For example, a contextual token may be a specific chord progression or musical composition that appears within the one or more media. Accordingly, the contextual token may be received and played on the musical instrument.

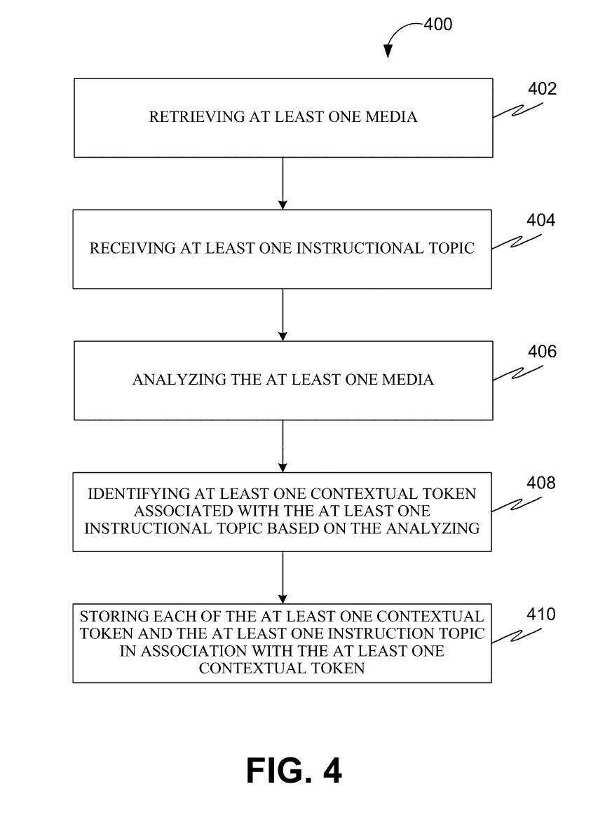

FIG. 4 illustrates a flowchart of a method 400 for facilitating provisioning of media for instructional use in accordance with some embodiments.

At 402, the method 400 includes retrieving, using a storage device (such as the storage device 202), one or more media. The one or more media comprises one or more of an audio content, a video content, a multimedia content.

At 404, the method 400 includes receiving, using a processing device (such as the processing device 204), one or more instructional topics.

At 406, the method 400 includes analyzing, using a processing device, the one or more media. Further, the analyzing may include performing one or both of image analysis and audio analysis.

At 408, the method 400 includes identifying, using the processing device, one or more contextual tokens associated with the one or more instructional topics based on the analyzing. The one or more contextual tokens may include one or more of a spelling feature, a vocabulary word, a literary concept, a scientific concept and a mathematical concept. In a further embodiment, the one or more contextual tokens may include multiple contextual tokens, wherein the method 400 may further include grouping the multiple contextual tokens into one or more contextual groups based on contextual similarity associated with the multiple contextual tokens

At 410, the method 400 includes storing, using the storage device, each of the one or more contextual tokens and the one or more instructional topics in association with the one or more contextual tokens.

In further embodiments, the method 400 may include identifying, using the processing device, the one or more instructional topics based on the analyzing, wherein the analyzing is performed based on one or more predetermined rules. For example, an expert may provide predetermined rules that may facilitate discovery of such instructional topics.

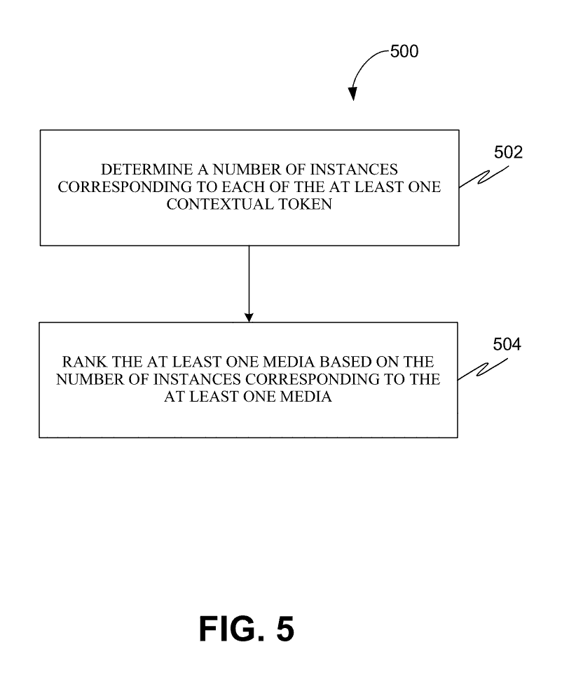

In further embodiments, the method 400 may include additional steps of a method 500 shown in FIG. 5. FIG. 5 illustrates a flowchart of the method 500 of ranking media for instructional use in accordance with some embodiments. At 502, the method 500 includes determining, using the processing device, a number of instances corresponding to each of the one or more contextual tokens. At 504, the method 500 includes ranking, using the processing device, the one or more media based on the number of instances corresponding to the one or more media. The method 500 ranks a media, which has more number of instances of a contextual token for a given instructional topic, higher than other media with fewer instances.

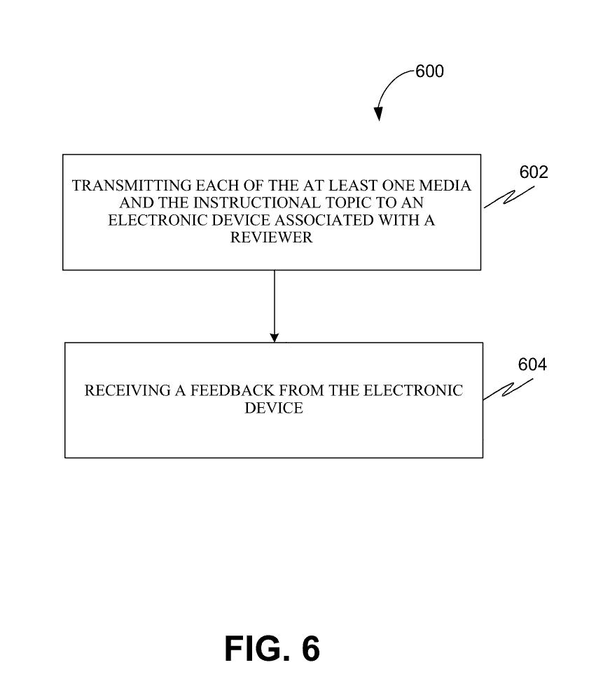

In further embodiments, the method 600 may include additional steps of a method 600 shown in FIG. 6. FIG. 6 illustrates a flowchart of the method 600 of reviewing media and instructional topic in accordance with some embodiments. At 602, the method 600 includes transmitting, using a communication device, each of the one or more media and the instructional topic to an electronic device associated with a reviewer. Thereafter, at 604, the method 600 includes receiving, using the communication device, a feedback from the electronic device. The feedback is provided by the reviewer, wherein the identifying of the one or more contextual tokens may be further based on the feedback. The feedback may include approval of the contextual token identified automatically by the invention. Alternatively, the feedback may be guidance provided by the expert that may facilitate identifying of the contextual token.

The method 600 may further include receiving using the communication device, one or more learner characteristics associated with the instructional topic. For example, the one or more learner characteristics may include reading level, age of learners, language, and culture. Accordingly, the identifying the one or more contextual tokens may be further based on the one or more learner characteristics.

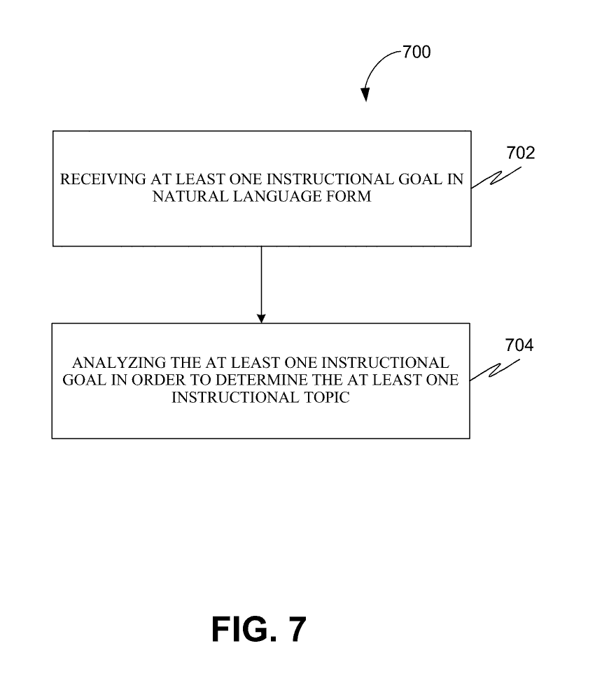

In further embodiments, the method 600 may include additional steps of a method 700 shown in FIG. 7. FIG. 7 illustrates a flowchart of the method 700 of receiving free form complex queries from instructors in accordance with some embodiments. At 702, the method 700 includes receiving, using the communication device, one or more instructional goals in natural language form. At 704, the method 700 includes analyzing, using the processing device 204, the one or more instructional goals in order to determine the one or more topics. The method 700 allows receiving free form complex queries from instructors which may then be analyzed in order to identify the instructional topics. The identified topics may then be used to retrieve the relevant media having the contextual tokens.

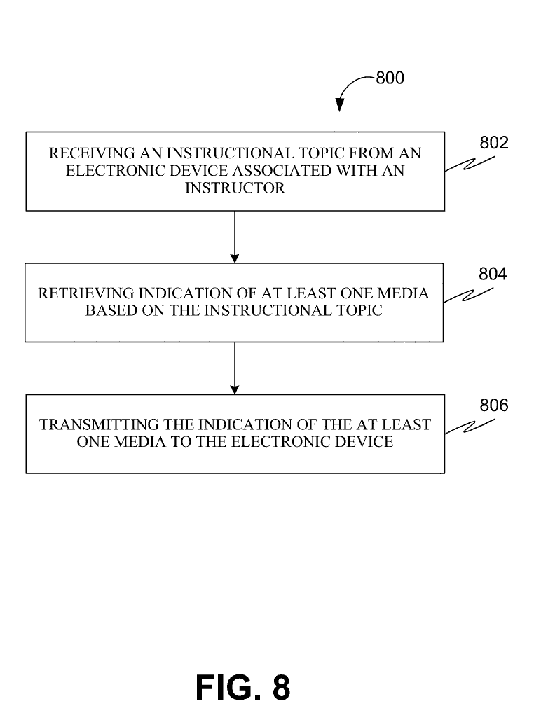

FIG. 8 illustrates a flowchart of a method 800 of provisioning of media for instructional use in accordance with some embodiments. At 802, the method 800 includes receiving, using a communication device, an instructional topic from an electronic device associated with an instructor. At 804, the method 800 includes retrieving, using a storage device, indication of one or more media based on the instructional topic. The one or more media may include one or more contextual tokens associated with the instructional topic. At 806, the method 800 includes transmitting, using the communication device, the indication of the one or more media to the electronic device. The method 800 enables instructor to receive an indication (such as title of a book) of one or more media on their electronic device. Thereafter, the instructor may request for access to the one or more media. For example, the instructor may need to make a payment to access the one or more media. In alternative embodiments, the one or more media may be transmitted to the instructor's device.

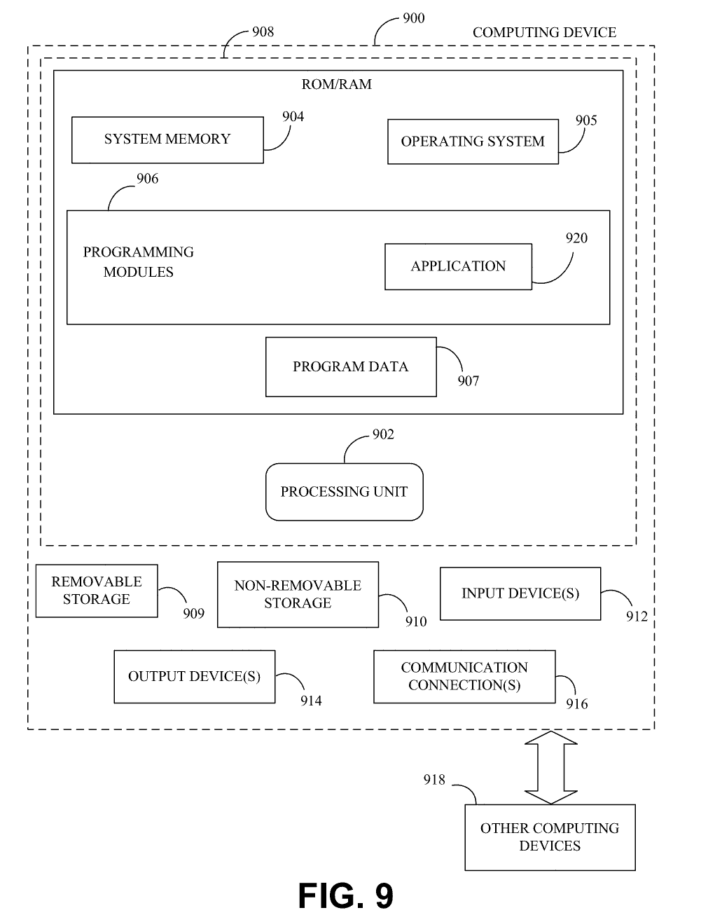

FIG. 9 is a block diagram of a system including computing device 900. Consistent with an embodiment of the disclosure, the aforementioned memory storage and processing unit may be implemented in a computing device, such as computing device 900 of FIG. 9. Any suitable combination of hardware, software, or firmware may be used to implement the memory storage and processing unit. For example, the memory storage and processing unit may be implemented with computing device 900 or any of other computing devices 918, in combination with computing device 900. The aforementioned system, device, and processors are examples and other systems, devices, and processors may comprise the aforementioned memory storage and processing unit, consistent with embodiments of the disclosure.

With reference to FIG. 9, a system consistent with an embodiment of the disclosure may include a computing device or cloud service, such as computing device 900. In a basic configuration, computing device 900 may include at least one processing unit 902 and a system memory 904. Depending on the configuration and type of computing device, system memory 904 may comprise, but is not limited to, volatile (e.g. random access memory (RAM)), non-volatile (e.g. read-only memory (ROM)), flash memory, or any combination. System memory 904 may include operating system 905, one or more programming modules 906, and may include a program data 907. Operating system 905, for example, may be suitable for controlling computing device 900's operation. In one embodiment, programming modules 906 may include image encoding module, machine learning module and image classifying module. Furthermore, embodiments of the disclosure may be practiced in conjunction with a graphics library, other operating systems, or any other application program and is not limited to any particular application or system. This basic configuration is illustrated in FIG. 9 by those components within a dashed line 908.

Computing device 900 may have additional features or functionality. For example, computing device 900 may also include additional data storage devices (removable and/or non-removable) such as, for example, magnetic disks, optical disks, or tape. Such additional storage is illustrated in FIG. 9 by a removable storage 909 and a non-removable storage 910. Computer storage media may include volatile and nonvolatile, removable and non-removable media implemented in any method or technology for storage of information, such as computer-readable instructions, data structures, program modules, or other data. System memory 904, removable storage 909, and non-removable storage 910 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 900. Any such computer storage media may be part of device 900. Computing device 900 may also have input device(s) 912 such as a keyboard, a mouse, a pen, a sound input device, a touch input device, etc. Output device(s) 914 such as a display, speakers, a printer, etc. may also be included. The aforementioned devices are examples and others may be used.

Computing device 900 may also contain a communication connection 916 that may allow device 900 to communicate with other computing devices 918, such as over a network in a distributed computing environment, for example, an intranet or the Internet. Communication connection 916 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 904, including operating system 905. While executing on processing unit 902, programming modules 906 (e.g., application 920) may perform processes including, for example, one or more stages of methods 400, 500, 600, 700 and 800 as described above. The aforementioned process is an example, and processing unit 902 may perform other processes. Other programming modules that may be used in accordance with embodiments of the present disclosure may include image encoding applications, machine learning application, image classifiers etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

### Detail Descriptions of the Embodiments

A method of facilitating provisioning for media for instructional use is provided. The method may include retrieving, using a storage device, at least one media. Further, the method may include receiving, using a processing device, at least one instructional topic. Further, the method may include analyzing, using a processing device, the at least one media. Further, the method may include identifying, using the processing device, at least one contextual token associated with the at least one instructional topic based on the analyzing. Further, the method may include storing, using the storage device, each of the at least one contextual token and the at least one instruction topic in association with the at least one contextual token.

In some embodiments, the method may further include identifying, using the processing device, the at least one instructional topic based on the analyzing. Further, the analyzing may be performed based on at least one predetermined rule.

In some embodiments, the at least one contextual token may include a plurality of contextual tokens. Further, the method may include grouping the plurality of contextual tokens into at least one contextual group based on contextual similarity associated with the plurality of contextual tokens.

In some embodiments, the method may further include determining, using the processing device, a number of instances corresponding to each of the at least one contextual token and ranking, using the processing device, the at least one media based on the number of instances corresponding to the at least one media.

In some embodiments, the method may further include transmitting, using a communication device, each of the at least one media and the instructional topic to an electronic device associated with a reviewer and receiving, using the communication device, a feedback from the electronic device. Further, the feedback may be provided by the reviewer. Further, the identifying of the at least one contextual token may be based on the feedback.

In some embodiments, the method may further include receiving, using the communication device, at least one instructional goal in natural language form and analyzing, using the processing device, the at least one instructional goal in order to determine the at least one instructional topic.

In some embodiments, the method may further include receiving, using the communication device, at least one learner characteristic associated with the instructional topic. Further, identifying the at least one contextual token may be based on the at least one learner characteristic.

In some embodiments, the at least one contextual token may include one or more of a spelling feature, a vocabulary word, a literary concept, a scientific concept and a mathematical concept.

In some embodiments, the at least one media may include one or more of an audio content, a video content, a multimedia content. Further, the analyzing may include performing one or more of image analysis and audio analysis.

A method of provisioning media for instructional use, the method may include receiving, using a communication device, an instructional topic from an electronic device associated with an instructor. Further, the method may include retrieving, using a storage device, an indication of at least one media based on the instructional topic. Further, the at least one media may include at least one contextual token associated with the instructional topic. Further, the method may include transmitting, using the communication device, the indication of the at least one media to the electronic device.

A system for facilitating provisioning of media for instructional use is also provided. The system may include a storage device configured for retrieving, using a storage device, at least one media. Further, the storage device is configured for storing, using the storage device, each of at least one contextual token and at least one instruction topic in association with the at least one contextual token. Additionally, the system may include a processing device configured for receiving, using a processing device, at least one instructional topic. Further, the processing device is configured for analyzing the at least one media. Further, the processing device may be configured for identifying the at least one contextual token associated with the at least one instructional topic based on the analyzing.

In some embodiments, the processing device may be further configured for identifying the at least one instructional topic based on the analyzing. Further, the analyzing may be performed based on at least one predetermined rule.

In some embodiments, the at least one contextual token may include a plurality of contextual tokens. Further, the system may include grouping the plurality of contextual tokens into at least one contextual group based on contextual similarity associated with the plurality of contextual tokens.

In some embodiments, the processing device may be further configured for determining a number of instances corresponding to each of the at least one contextual token and ranking the at least one media based on the number of instances corresponding to the at least one media.

In some embodiments, the system may further include a communication device configured for transmitting each of the at least one media and the instructional topic to an electronic device associated with a reviewer and receiving a feedback from the electronic device. Further, the feedback may be provided by the reviewer. Further, the identifying of the at least one contextual token may be based on the feedback.

In some embodiments, the communication device may be further configured for receiving at least one instructional goal in natural language form. Further, the processing device may be further configured for analyzing the at least one instructional goal in order to determine the at least one instructional topic.

In some embodiments, the communication device may be further configured for receiving at least one learner characteristic associated with the instructional topic. Further, the identifying of the at least one contextual token may be based on the at least one learner characteristic.

In some embodiments, the at least one contextual token may include one or more of a spelling feature, a vocabulary word, a literary concept, a scientific concept and a mathematical concept.

In some embodiments, the at least one media may include one or more of an audio content, a video content, a multimedia content. Further, the analyzing may include performing one or more of image analysis and audio analysis.

In some embodiments, the at least one instructional topic corresponds to music. Further, the communication device may be configured to transmit the at least one contextual token to a musical instrument. Further, the musical instrument may be configured to play the at least one contextual token.

Although the invention has been explained in relation to its preferred embodiment, it is to be understood that many other possible modifications and variations can be made without departing from the spirit and scope of the invention.

What is claimed is:

1. A method for facilitating provisioning of media for instructional use, the method comprising:
retrieving, using a storage device, at least one media;
receiving, using a processing device, at least one instructional topic;
analyzing, using a processing device, the at least one media;
identifying, using the processing device, at least one contextual token associated with the at least one instructional topic based on the analyzing; and
storing, using the storage device, each of the at least one contextual token and the at least one instruction topic in association with the at least one contextual token.

2. The method of claim 1 further comprising identifying, using the processing device, the at least one instructional topic based on the analyzing, wherein the analyzing is performed based on at least one predetermined rule.

3. The method of claim 1, wherein the at least one contextual token comprises a plurality of contextual tokens, wherein the method further comprises grouping the plurality of contextual tokens into at least one contextual group based on contextual similarity associated with the plurality of contextual tokens.

4. The method of claim 1 further comprising:
determining, using the processing device, a number of instances corresponding to each of the at least one contextual token; and
ranking, using the processing device, the at least one media based on the number of instances corresponding to the at least one media.

5. The method of claim 1 further comprising:
transmitting, using a communication device, each of the at least one media and the instructional topic to an electronic device associated with a reviewer; and
receiving, using the communication device, a feedback from the electronic device, wherein the feedback is provided by the reviewer, wherein the identifying of the at least one contextual token is further based on the feedback.

6. The method of claim 5 further comprising:
receiving, using the communication device, at least one instructional goal in natural language form; and
analyzing, using the processing device, the at least one instructional goal in order to determine the at least one instructional topic.

7. The method of claim 5 further comprising receiving, using the communication device, at least one learner characteristic associated with the instructional topic, wherein identifying the at least one contextual token is further based on the at least one learner characteristic.

8. The method of claim 1, wherein the at least one contextual token comprises at least one of a spelling feature, a vocabulary word, a literary concept, a scientific concept and a mathematical concept.

9. The method of claim 1, wherein the at least one media comprises at least one of an audio content, a video content, a multimedia content, wherein the analyzing comprises performing at least one of image analysis and audio analysis.

10. A method for provisioning media for instructional use, the method comprising:
receiving, using a communication device, an instructional topic from an electronic device associated with an instructor;
retrieving, using a storage device, indication of at least one media based on the instructional topic, wherein the at least one media comprises at least one contextual token associated with the instructional topic; and
transmitting, using the communication device, the indication of the at least one media to the electronic device.

11. A system for facilitating provisioning of media for instructional use, the system comprising:
a storage device configured for:
retrieving, using a storage device, at least one media;
storing, using the storage device, each of at least one contextual token and at least one instruction topic in association with the at least one contextual token.
a processing device configured for:
receiving, using a processing device, at least one instructional topic;
analyzing, using a processing device, the at least one media;
identifying, using the processing device, the at least one contextual token associated with the at least one instructional topic based on the analyzing.

12. The system of claim 11, wherein the processing device is further configured for identifying the at least one instructional topic based on the analyzing, wherein the analyzing is performed based on at least one predetermined rule.

13. The system of claim 11, wherein the at least one contextual token comprises a plurality of contextual tokens, wherein the system further comprises grouping the plurality of contextual tokens into at least one contextual group based on contextual similarity associated with the plurality of contextual tokens.

14. The system of claim 11, wherein the processing device is further configured for:
determining a number of instances corresponding to each of the at least one contextual token; and
ranking the at least one media based on the number of instances corresponding to the at least one media.

15. The system of claim 11 further comprising a communication device configured for:
transmitting each of the at least one media and the instructional topic to an electronic device associated with a reviewer; and
receiving a feedback from the electronic device, wherein the feedback is provided by the reviewer, wherein the identifying of the at least one contextual token is further based on the feedback.

16. The system of claim 15, wherein the communication device is further configured for receiving at least one instructional goal in natural language form, wherein the processing device is further configured for analyzing the at least one instructional goal in order to determine the at least one instructional topic.

17. The system of claim 15, wherein the communication device is further configured for receiving at least one learner characteristic associated with the instructional topic, wherein the identifying of the at least one contextual token is further based on the at least one learner characteristic.

18. The system of claim 11, wherein the at least one contextual token comprises at least one of a spelling feature, a vocabulary word, a literary concept, a scientific concept and a mathematical concept.

19. The system of claim 11, wherein the at least one media comprises at least one of an audio content, a video content, a multimedia content, wherein the analyzing comprises performing at least one of image analysis and audio analysis.

20. The system of claim 19, wherein the at least one instructional topic corresponds to music, wherein the communication device is configured to transmit the at least one contextual token to a musical instrument, wherein the musical instrument is configured to play the at least one contextual token.
